(19) United States
(12) Patent Application Publication
(10) Pub. No.: US 2020/0334084 A1
(43) Pub. Date: Oct. 22, 2020

(54) DISTRIBUTED IN-PLATFORM DATA STORAGE UTILIZING GRAPHICS PROCESSING UNIT (GPU) MEMORY

(71) Applicant: KAZUHM, INC., San Diego, CA (US)

(72) Inventor: Joshua Owen JACOBSON, San Diego, CA (US)

(21) Appl. No.: 16/385,283

(22) Filed: Apr. 16, 2019

(51) Int. Cl. G06F 9/50; G06F 9/455; G06F 11/30; G06F 9/38

(52) U.S. Cl. CPC G06F 9/5016; G06F 9/45558; G06F 2009/45583; G06F 9/3877; G06F 11/3037

(57) ABSTRACT

Certain aspects of the present disclosure provide methods and systems for in-platform data storage. Embodiments include receiving data for storage in a distributed computing platform. Embodiments include determining that graphics processing unit (GPU) memory resources are available. Embodiments include storing the data in the GPU memory resources. Embodiments include monitoring demand for the GPU memory resources in the distributed computing platform. Embodiments include identifying a contention for the GPU memory resources. Embodiments include evacuating the data from the GPU memory resources based on the contention.

### INTRODUCTION

Aspects of the present disclosure relate to systems and methods for performing data processing on distributed computing resources.

Computing is increasingly ubiquitous in modern life, and the demand for computing resources is increasing at a substantial rate. Organizations of all types are finding reasons to analyze more and more data to their respective ends.

Many complimentary technologies have changed the way data processing is handled for various users and organizations. For example, improvements in networking performance and availability (e.g., via the Internet) have enabled organizations to rely on cloud-based computing resources for data processing rather than building out dedicated, high-performance computing infrastructure to perform the data processing. The promise of cloud-based computing resource providers is that such resources are cheaper, more reliable, easily scalable, and such resources do not require any high-performance on-site computing equipment. Unfortunately, the various promises relating to cloud-based computing have not all come to fruition. In particular, the cost of cloud-based computing resources has turned out in many cases to be as or even more expensive than building dedicated on-site hardware for data processing needs. Moreover, cloud-based computing exposes organizations to certain challenges and risks, such as data custody and privacy.

Many organizations have significant amounts of non-dedicated and/or non-special purpose processing resources, which are rarely used anywhere near their processing capacity. However, such organizations are generally not able to leverage all of their existing computing resources for processing intensive tasks. Rather, each of the organization's general purpose processing resources is generally used only for general purpose tasks. Clearly, such organizations would significantly benefit from leveraging the non-dedicated and/or non-special purpose computing resources in an orchestrated fashion for processing intensive tasks.

In particular, many computing systems have a graphics processing unit (GPU) with significant onboard memory. GPU memory is generally used to store data related to processing of graphics, such as texture data. As such, a significant portion of GPU memory frequently goes unused, particularly when graphics-intensive applications are not being run. Furthermore, GPU memory is often not even counted in a computer's overall memory/storage statistics.

Accordingly, systems and methods are needed to enable organizations to leverage unutilized or underutilized general purpose computing resources, such as GPU memory, for distributed data storage.

### BRIEF SUMMARY

Certain embodiments provide a method for storing data in a distributed computing system. In one implementation, the method includes: receiving data for storage in a distributed computing platform; determining that graphics processing unit (GPU) memory resources are available; storing the data in the GPU memory resources; monitoring demand for the GPU memory resources in the distributed computing platform; identifying a contention for the GPU memory resources; and evacuating the data from the GPU memory resources based on the contention.

Other embodiments provide a non-transitory computer-readable medium comprising instructions to perform the method for storing data in a distributed computing system. Further embodiments provide an apparatus configured to perform the method for storing data in a distributed computing system.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an embodiment of a heterogeneous distributed computing resource management system.

FIG. 2 depicts example components of a node in a heterogeneous distributed computing resource management system.

FIG. 3 depicts an example of storing data in GPU memory in a heterogeneous distributed computing resource management system.

FIG. 4 depicts example operations for storing data in a distributed computing system.

FIG. 5 depicts example operations for storing data in a distributed computing system.

FIG. 6 depicts a computing system that may be used to perform methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for leveraging general purpose computing resources for distributed data storage, such as utilizing available graphics processing unit (GPU) memory resources.

Organizations have many types of computing resources that may go underutilized during every day. Many of these computing resources (e.g., desktop and laptop computers) are significantly powerful despite being general-use resources. For example, many computing systems have a GPU with substantial amounts of memory resources that are frequently unutilized. Thus, a distributed computing system that can unify these disparate computing resources into a high-performance computing environment may provide several benefits, including: a decrease in cost of processing and storing data related to organization workloads, and an increase in the organization's ability to protect information related to the storing and processing of workloads by processing those workloads on-site in organization-controlled environments. In fact, for some organizations, such as those that deal with sensitive information, on-site storage and processing is the only option because sensitive information may not be allowed to be stored or processed using off-site computing resources, such as cloud-based resources.

Described herein is a cross-platform system of components necessary to unify computing resources in a manner that efficiently stores and processes organizational workloads and related data—without the need for special-purpose on-site computing hardware, or reliance on off-site cloud-computing resources. This unification of computing resources can be referred to as distributed computing, peer computing, high-throughput computing (HTC), or high-performance computing (HPC). Further, because such a cross-platform system may leverage many types of computing resources within a single, organized system, the system may be referred to as a heterogeneous distributed computing resource management system. The heterogeneous distributed computing systems and methods described herein may be used by organizations to handle significant and complex data storage and processing.

One aspect of a heterogeneous distributed computing resource management system is the use of containers across the system of heterogeneous computing resources. A distributed computing system manager may orchestrate containers, applications resident in those containers, workloads handled by those applications, and data related to those workloads in a manner that delivers maximum performance and value to organizations simultaneously. For example, such a system may be used to distribute storage and processing related to the training of complex machine learning models, such as neural networks and deep learning models.

In certain embodiments, GPU memory resources of computing systems in a distributed computing resource management system are monitored in order to identify unutilized portions of GPU memory. For example, when a given computer is idle, its GPU memory may be substantially unutilized. As such, embodiments described herein involve making use of unutilized GPU memory resources to store workloads and other types of data, such as data sets operated on by workloads.

In certain embodiments described herein, data is stored in GPU memory as texture data, direct memory buffers, or higher-level software abstractions (e.g., allocating memory on the device heap).

In order to avoid interfering with normal use of system resources, certain embodiments involve monitoring demand for GPU memory resources on an ongoing basis so that, in the event of a contention for GPU memory resources, data stored in the GPU by the heterogeneous distributed computing system manager may be evacuated from the GPU memory to another location. For example, if the heterogeneous distributed computing resource management system has stored data in the GPU memory of a given computer, and then determines that another application on the computer, such as a graphical application, is demanding access to the GPU memory, the data may be removed from the GPU memory and placed in another location, such as system memory or another local or remote memory. As such, GPU memory resources may be utilized in a non-intrusive manner that does not prevent the GPU memory from being used for general purposes during regular operation of the computer. It is noted that, as used herein, data may refer to files, portions of files, bitstreams, or other units of data.

There are many advantages of a heterogeneous distributed computing resource management system as compared to the conventional solutions described above. For example, on-site purpose-built hardware rapidly becomes obsolete in performance and capability despite the high-cost of designing, installing, operating, and maintaining such systems. Such systems tend to require homogeneous underlying equipment and tend not to be capable of interacting with other computing resources that are not likewise purpose-built. Further, such systems are not easily upgradeable. Rather, they tend to require extensive and costly overhauls on long intervals meaning that in the time between major overhauls, those systems slowly degrade in their relative performance. By contrast, the heterogeneous distributed computing resource management system described herein can leverage any sort of computing device within an organization through the use of the containers. Because such computing devices are more regularly turned over (e.g., replaced with newer devices), the capability of the system as a whole is continually increasing, but without any special purpose organizational spend. For example, every time a general purpose desktop workstation, laptop, or server is replaced, its improved capabilities are made available to the distributed system.

Another significant advantage is increasing the utilization of existing computing resources, such as GPU memory resources. The average general-purpose desktop workstation or laptop is significantly more powerful than what it is regularly used for. In other words, internet browsing, word processing applications, email, normal graphics processing, etc., do not even come close in most cases to utilizing the full potential of these computing resources. This is true of servers and special purposes machines as well. Servers rarely run at their actual capacity, and special purpose computers (e.g., high-end graphic rendering computers) may only be used for one third or less of a day (e.g., during the workday) at anywhere near their capacity. The ability to utilize the vast number and capability of existing organizational computing resources means that an organization can accomplish much more without having to buy more computing resources, upgrade existing computing resources, rely solely on cloud-based computing resources, etc.

Yet another advantage of a heterogeneous distributed computing resource management system is reducing single points of failure from the system. For example, in a dedicated system or when relying solely on a cloud-based computing service, an organization is at operational risk of the dedicated system or cloud-based computing service going down. When instead relying on a distributed group of computing resources, the failure of any one, or even several resources, will only have a marginal impact on the distributed system as a whole. That is, a heterogeneous distributed computing resource management system is more fault tolerant than dedicated systems or cloud-based computing services from the organization's perspective.

The ability to harness even more of the underlying capability of general purpose computers integrated into the heterogeneous distributed computing resource management system, such as by leveraging heretofore inaccessible GPU resources, further the various advantages described above.

### Example Heterogeneous Distributed Computing Resource Management System

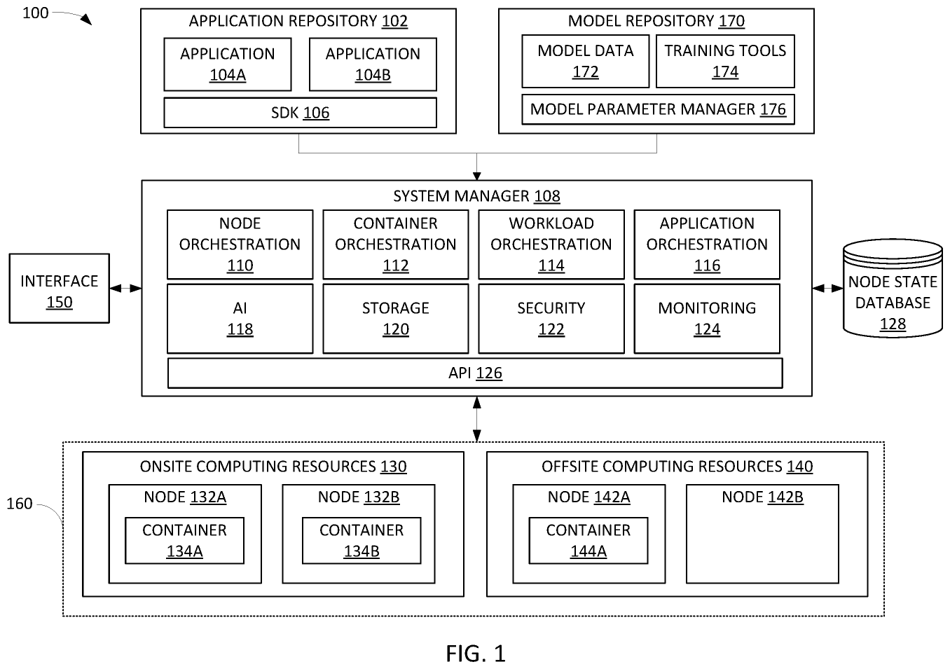

FIG. 1 depicts an embodiment of a heterogeneous distributed computing resource management system 100. For example, techniques described herein for utilizing available GPU memory resources for data storage may be implemented in heterogeneous distributed computing resource management system 100, such as on one or more of nodes 132A, 132B, or 142A.

Management system 100 includes an application repository 102. Application repository 102 stores and makes accessible applications, such as applications 104A-B. Applications 104A-B may be used by system 100 in containers deployed on remote resources managed by management system 100, such as containers 134A, 134B, and 144A. In some examples, application repository 102 may act as an application marketplace for developers to market their applications.

Application repository 102 includes a software development kit (SDK) 106, which may include a set of software development tools that allows the creation of applications (such as applications 104A-B) for a certain software package, software framework, hardware platform, computer system, video game console, operating system, or similar development platform. SDK 106 allows software developers to develop applications (such as applications 104A-104B), which may be deployed within management system 100, such as to containers 134A, 134B, and 144A.

Some SDKs are critical for developing a platform-specific application. For example, the development of an Android app on Java platform requires a Java Development Kit, for iOS apps the iOS SDK, for Universal Windows Platform the .NET Framework SDK, and others. There are also SDKs that are installed in apps to provide analytics and data about activity. In some cases, and SDK may implement one or more application programming interfaces (APIs) in the form of on-device libraries to interface to a particular programming language, or to include sophisticated hardware that can communicate with a particular embedded system. Common tools include debugging facilities and other utilities, often presented in an integrated development environment (IDE). Note, though shown as a single SDK 106 in FIG. 1, SDK 106 may include multiple SDKs.

Management system 100 also includes system manager 108. System manager 108 may alternatively be referred to as the “system management core” or just the “core” of management system 100. System manager 108 includes many modules, including a node orchestration module 110, container orchestration module 112, workload orchestration module 114, application orchestration module 116, AI module 118, storage module 120, security module 122, and monitoring module 124. Notably, in other embodiments, system manager 108 may include only a subset of the aforementioned modules, while in yet other embodiments, system manager 108 may include additional modules. In some embodiments, various modules may be combined functionally.

Node orchestration module 110 is configured to manage nodes associated with management system 100. For example, node orchestration module 110 may monitor whether a particular node is online as well as status information associated with each node, such as what the processing capacity of the node is, what the network capacity of the node is, what type of network connection the node has, what the memory capacity of the node is (e.g., which may include GPU memory), what the storage capacity of the node is, what the battery power of the node is (if it is a mobile node not running on batter power), etc. Node orchestration module 110 may share status information with artificial intelligence (AI) module 118. Node orchestration module 110 may receive messages from nodes as they come online in order to make them available to management system 100 and may also receive status messages from active nodes in the system.

Node orchestration module 110 may also control the configuration of certain nodes according to predefined node profiles. For example, node orchestration module 110 may assign a node (e.g., 132A, 132B, or 142A) as a processing node, a storage node, a security node, a monitoring node, or other types of nodes.

A processing node may generally be tasked with data processing by management system 100. As such, processing nodes may tend to have high processing capacity and availability. In some cases, processing nodes may have significant GPU resources, including GPU processors and memory. Processing nodes may also tend to have more applications installed in their respective containers compared to other types of nodes. In some examples, processing nodes may be used for training models, such as complex machine learning models, including neural network and deep learning models.

A storage node may generally be tasked with data storage. As such, storage nodes may tend to have high storage availability. In some cases, a storage node may have a large amount of underutilized GPU memory.

A security node may be tasked with security related tasks, such as monitoring activity of other nodes, including nodes in common sub-pool of resources, and reporting that activity back to security module 122. A security node may also have certain, security related types of applications, such as virus scanners, intrusion detection software, etc.

A monitoring node may be tasked with monitoring related tasks, such as monitoring activity of other nodes, including nodes in a common sub-pool of resources, and reporting that activity back to node orchestration module 110 or monitoring module 124. Such activity may include the nodes availability, the nodes connection quality, and other such data.

Not all nodes need to be a specific type of node. For example, there may be general purpose nodes that include capabilities associated with one or more of processing, storage, security, and monitoring. Further, there may be other specific types of nodes, such as machine learning model training or execution nodes.

Container orchestration module 112 manages the deployment of containers to various nodes, such as containers 134A, 134B, and 144A to nodes 132A, 132B, and 142A, respectively. For example, container orchestration module 112 may control the installation of containers in nodes, such as 142B, which are known to management system 100, but which do not yet have containers. In some cases, container orchestration module 112 may interact with node orchestration module 110 and/or monitoring module 124 to determine the status of various containers on various nodes associated with system 100.

Workload orchestration module 114 is configured to manage workloads distributed to various nodes, such as nodes 132A, 132B, and 142A. For example, when a job is received by management system 100, for example by way of interface 150, workload orchestration module 114 may distribute the job to one or more nodes for processing. In particular, workload orchestration module 114 may receive node status information from node orchestration module 110 and distribute the job to one or more nodes in such a way as to optimize processing time and maximize resources utilization based on the status of the nodes connected to the system.

In some cases, when a node becomes unavailable (e.g., goes offline) or becomes insufficiently available (e.g., does not have adequate processing capacity), workload orchestration module 114 will reassign the job to one or more other nodes. For example, if workload orchestration module 114 had initially assigned a job to node 132A, but then node 132A went offline, then workload orchestration module 114 may reassign the job to node 132B. In some cases, the reassignment of a job may include the entire job, or just a portion of a job that was not yet completed by the original assigned node.

In another example, if workload orchestration module 114 had initially allocated storage to a GPU of node 132A, and the GPU of node 132A then becomes busy, then workload orchestration module 114 may reallocate the memory space to a different node (e.g., to a GPU of node 132B).

Workload orchestration module 114 may also provide splitting (or chunking) operations. Splitting or chunking is the act of breaking a large processing job down in to small parts that can be processed by multiple processing nodes at once (i.e., in parallel). Notably, workload orchestration may be handled by system manager 108 as well as by one or more nodes. For example, an instance of workload orchestration module 114 may be loaded onto a node to manage workload within a sub-pool of resources in a peer-to-peer fashion in case access to system manager 108 is not always available.

Workload orchestration module 114 may also include scheduling capabilities. For example, schedules may be configured to manage computing resources (e.g., nodes 132A, 132B, and 142A) according to custom schedules to prevent resource over-utilization, or to otherwise prevent interruption with a nodes primary purpose (e.g., being an employee workstation).

In one example, a node may configure such that it can be used by system 100 only during certain hours of the day. In some cases, multiple levels of resource management may be configured. For example, a first percentage of processing resources at a given node may be allowed during a first time interval (e.g., during working hours) and a second percentage of processing resources may be allowed during a second time interval (e.g., during non-working hours). In this way, the nodes can be configured for maximum resource utilization without negatively affecting end-user experience with the nodes during regular operation (i.e., operation unrelated to system 100). In some cases, schedules may be set through interface 150.

In another example, a first percentage of memory resources (e.g., GPU memory resources) at a given node may be allowed during a first time interval (e.g., during working hours) and a second percentage of memory resources (e.g., GPU memory resources) may be allowed during a second time interval (e.g., during non-working hours). In this way, the nodes can be configured for maximum resource utilization without negatively affecting end-user experience with the nodes during regular operation (i.e., operation unrelated to system 100). In some cases, schedules may be set through interface 150.

In the example depicted in FIG. 1, workload orchestration module 114 is a part of system manager 108, but in other examples an orchestration module may be resident on a particular node, such as node 132A, to manage the resident node's resources as well as other node's resources in a peer-to-peer management scheme. This may allow, for example, jobs to be managed by a node locally while the node moves in and out of connectivity with system manager 108. In such cases, the node-specific instantiation of a node orchestration module may nevertheless be a “slave” to the master node orchestration module 110.

Application orchestration module 116 manages which applications are installed in which containers, such as containers 134A, 134B, and 144A. For example, workflow orchestration module 114 may assign a job to a node that does not currently have the appropriate application installed to perform the job. In such a case, application orchestration module 116 may cause the application to be installed in the container from, for example, application repository 102. In one example, application orchestration module 116 causes a GPU interface application, such as the compute unified device application (CUDA®) platform by NVIDIA®, AMD® Radeon™ drivers, Intel® Iris® drivers, or another component that allows container 134A to have device-level access to GPU memory resources of node 134A to be installed in container 134A.

Application orchestration module 116 is further configured to manage applications once they are installed in containers, such as in containers 134A, 134B, and 144A. For example, application orchestration module 116 may enable or disable applications installed in containers, grant user permissions related to the applications, and grant access to resources. Application orchestration module 116 enables a software developer to, for example, upload new applications, remove applications, manage subscriptions associated with applications, and receive data regarding applications (e.g., number of downloads, installs, active users, etc.) in application repository 102, among other things.

In some examples, application orchestration module 116 may manage the initial installation of applications (such as 104A-104D) in containers on nodes. For example, if a container was installed in node 142B, application orchestration module 116 may direct an initial set of applications to be installed on node 142B. In some cases, the initial set of applications to be installed on a node may be based on a profile associated with the node. In other cases, the initial set of applications may be based on status information associated with the node (such as collected by node orchestration module 110). For example, if a particular node does not regularly have significant unused processing capacity or unused memory capacity (e.g., GPU memory), application orchestration module 116 may determine not to install certain applications that require significant processing capacity.

Like workload orchestration module 114, in some cases application orchestration module 116 may be installed on a particular node to manage deployment of applications in a cluster of nodes. As above, this may reduce reliance on system manager 108 in situations such as intermittent connectivity. And as with the workload orchestration module 114, a node-specific instantiation of an application orchestration module may be a slave to a master application orchestration module 116 running as part of system manager 108.

AI module 118 may be configured to interact with various aspects of management system 100 (e.g., node orchestration module 110, container orchestration module 112, workload orchestration module 114, application orchestration module 116, storage module 120, security module 122, and monitoring module 124) in order to optimize the performance of management system 100. For example, AI module 118 may monitor performance characteristics associated with various nodes and feedback workload optimizations to workload orchestration module 114. Likewise, AI module 118 may monitor network activity between various nodes to determine aberrations in the network activity and to thereafter alert security module 122.

AI module 118 may include a variety of machine-learning models in order to analyze data associated with management system 100 and to optimize its performance. AI module 118 may further include data preprocessing and model training capabilities for creating and maintaining machine learning models.

Storage module 120 may be configured to manage storage nodes associated with management system 100. For example, storage module 120 may monitor status of storage allocations, both long-term and short-term, within management system 100. In some cases, storage module 120 may interact with workload orchestration module 114 in order to distribute data associated with jobs, or portions of jobs to various nodes for short-term or long-term storage. In some cases, storage module 120 may allocate memory, such as GPU memory, to be used by workload orchestration module 114. Further, storage module 120 may report such status information to application orchestration module 116 to determine whether certain nodes have enough memory and/or storage available for certain applications to be installed on those nodes. Storage information collected by storage module 120 may also be shared with AI module 118 for use in system optimization.

Security module 122 may be configured to monitor management system 100 for any security breaches, such as unauthorized attempts to access containers, unauthorized job assignment, etc. Security module 122 may also manage secure connection generation between various nodes (e.g., 132A, 132B, and 142A) and system manager 108. In some cases, security module 122 may also handle user authentication, e.g., with respect to interface 150. Further, security module 122 may provide connectivity back to enterprise security information and event management (STEM) software through, for example, application programming interface (API) 126.

In some cases, security module 122 may observe secure operating behavior in the environment and make necessary adjustments if a security situation is observed. For example, security module 122 may use machine learning, advanced statistical analysis, and other analytic methods to flag potential security issues within management system 100.

Monitoring module 124 may be configured to monitor the performance of management system 100. For example, monitoring module 124 may monitor and record data regarding the performance of various jobs (e.g., how long the job took, how many nodes were involved, how much network traffic the job created, what percentage processing capacity was used at a particular node, what percentage of memory capacity was used (e.g., including general system memory and/or GPU memory), and others.

Monitoring module may generate analytics based on the performance of system 100 and share them with other aspects of management system 100. For example, monitoring module 124 may provide the monitoring information to AI module 118 to further enhance system performance. As another example, the analytics may be displayed in interface 150 so a system user may determine system performance and potentially change various parameters of system 100. In other embodiments, there may be a separate analytics module (not depicted) that is focused on the generation of analytics for system 100.

Monitoring module 124 may also provide the monitoring data to interface 150 in order to display system performance metrics to a user. For example, the monitoring data may be useful to report key performance indicators (KPIs) on a user dashboard.

Application programming interface (API) 126 may be configured to allow any of the aforementioned modules to interact with nodes (e.g., 132A, 132B, and 142A) or containers (e.g., 134A, 134B, or 144A). Further, API 126 may be configured to connect third-party applications and capabilities to management system 100. For example, API 126 may provide a connection to third-party storage systems, such as AMAZON S3®, EGNYTE®, and DROPBOX®, among others.

Management system 100 includes a pool of computing resources 160. The computing resources include on-site computing resources 130, which may include all resources in a particular location (e.g., a building). For example, an organization may have an office with many general purpose computing resources, such as desktop computers, laptop computers, servers, and other types of computing resources as well. Each one of these resources may be a node into which a container and applications may be installed.

Resource pool 160 may also include off-site computing resources 140, such as remote computers, servers, etc. Off-site computing resources 140 may be connected to management system 100 by way of network connections, such as a wide area network connection (e.g., the Internet) or via a cellular data connection (e.g., LTE, 5G, etc.), or by any other data-capable network. Off-site computing resources 140 may also include third-party resources, such as cloud computing resource providers, in some cases. Such third-party services may be able to interact with management system 100 by way of API 126.

Nodes 132A, 132B, and 142A may be any sort of computing resource that is capable of having a container installed on it. For example, nodes 132A, 132B, and 142A may be desktop computers, laptop computers, tablet computers, smartphones, other smart devices, servers, gaming consoles, or any other sort of computing device. In many cases, nodes 132A, 132B, and 142A will be general purpose computing devices.

Management system 100 includes model repository 170. Model repository 170 includes model data 172, which may include data relating to trained models (including parameters), training data, validation data, model results, and others. Model repository 170 also includes training tools 174, which may include tools, SDKs, algorithms, hyperparameters, and other data related to training models, such as machine learning models, including neural network and deep learning models. Model repository 170 also includes model parameter manager 176, which interfaces with system manager 108 to manage model parameters when system manager 108 has distributed model training across a plurality of nodes, such as nodes 132A, 132B, and 142A.

Management system 100 includes node state database 128, which stores information regarding nodes in resource pool 160, including, for example, hardware configurations and software configurations of each node, which may be referred to as static status information. Static status information may include configuration details such as CPU and GPU types, clock speed, memory size and type (e.g., general system memory or GPU memory), disks available, network interface capability, firewall presence and settings, proxy and other server configuration (e.g., HTTP), presence and configuration of NTP servers, type and version of the operating system, applications installed on node, etc. In general, static status information comprises configuration information about a node that is not transient.

Node state database 128 may also store dynamic information regarding nodes in resource pool 160, such as the usage state of each node (e.g., power state, network connectivity speed and state, percentage of CPU and/or GPU usage, including usage of specific cores, percentage of memory usage, active network connections, active network requests, network status, network connections rate, service usages (e.g., SSH, VPN, DNS, etc.), networking usage (sockets, packets, errors, ICMP, TCP, UDP, explicit congestion notification, etc.), usage alerts and alarms, stats with quick refresh rate, synchronization, machine utilization, system temperatures, and machine learning analytics (e.g., using graphs, heat maps, and geological dashboards), availability of unused resources (e.g., for rent via a system marketplace), etc.). In general, dynamic status information comprises transient operational information about a node, though such information may be transformed into representative statistical data, such as averages (e.g., average percentage of CPU and/or GPU processing and/or memory use, etc.).

In this example node state database 128 is shown separate from system manager 108, but in other embodiments node state database 128 may be another aspect of system manager 108.

Interface 150 provides a user interface for users to interact with system manager 108. For example, interface 150 may provide a graphical user interface (e.g., a dashboard) for users to schedule jobs, check the status of jobs, check the status of management system 100, configure management system 100, etc.

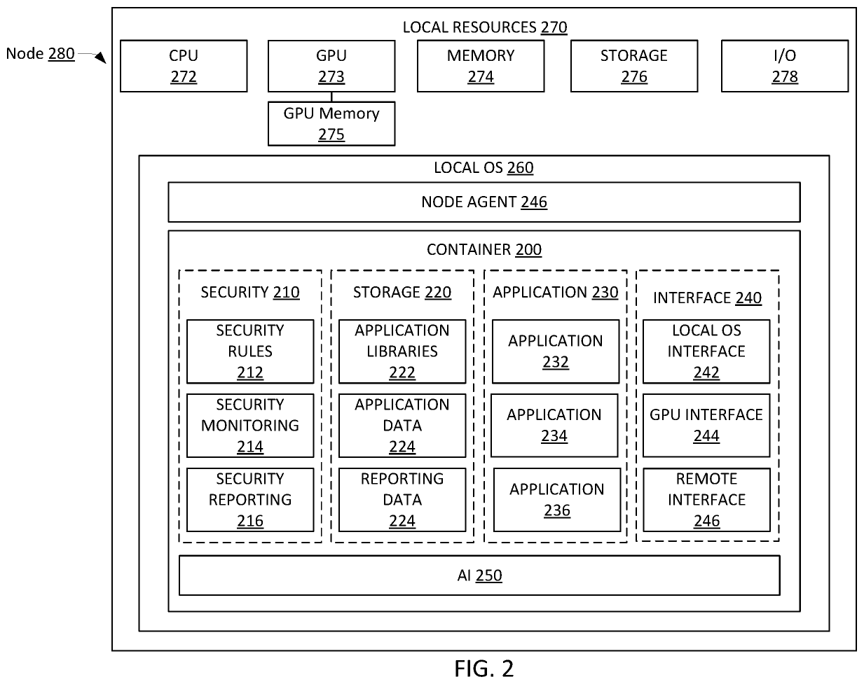

FIG. 2 depicts example components of a node in a heterogeneous distributed computing resource management system, such as resource pool 160 in FIG. 1.

In examples described herein, available GPU memory 275 may be used on node 280 to store data, such as data received for storage by node agent 246 from system manager 108 of FIG. 1 or data related to processing of workloads received from by node agent 246 from system manager 108 of FIG. 1 and processed, for example, within container 200.

As depicted, container 200 is resident within and interacts with a local operating system (OS) 260. Containers offer many advantages, such as isolation, extra security, simplified deployment and, most importantly, the ability to run non-native applications on a machine with a local OS (e.g., running LINUX® apps on WINDOWS® machines).

In this example, container 200 includes a local OS interface 242, which may be configured based on the type of local OS 260 (e.g., a WINDOWS® interface, a MAC OS® interface, a LINUX® interface, or any other type of operating system). By interfacing with local OS 260, container 200 need not have its own operating system (like a virtual machine) and therefore container 200 may be significantly smaller in size as compared to a virtual machine. The ability for container 200 to be significantly smaller in installed footprint means that container 200 works more readily with a wide variety of computing resources, including those with relatively small storage spaces (e.g., certain types of mobile devices).

Container 200 includes several layers, including (in this example) security layer 210, storage layer 220, application layer 230, and interface layer 240.

Security layer 210 includes security rules 212, which may define local security policies for container 200. For example, security rules 212 may define the types of jobs container 200 is allowed to perform, the types of data container 200 is allowed to interact with, etc. In some cases, security rules 212 may be defined by and received from security module 122 as described with respect to FIG. 1, above. In some cases, the security rules 212 may be defined by an organization's STEM software as part of container 200 being installed on node 280.

Security layer 210 also includes security monitoring module 214, which may be configured to monitor activity related to container 200 as well as node 280. In some cases, security monitoring module 214 may be configured by, or under control of, security module 122 as described with respect to FIG. 1, above. For example, in some cases security monitoring module 214 may be a local instance of security module 122, which is capable of working with or without connection to management system 100, described with respect to FIG. 1, above. This configuration may be particularly useful where certain computing resources are not connected to outside networks for security reasons, such as in the case of secure compartmentalized information facilities (SCIFs).

Security layer 210 also includes security reporting module 216, which may be configured to provide regular, periodic reports of the security state of container 200, as well as event-based specific reports of security issues. For example, security reporting module 216 may report back to security module 122 (in FIG. 1) any condition of container 200, local OS 260, or node 280, which suggests a potential security issue, such as a breach of one of security rules 212.

In some cases, security layer 210 may interact with AI 250. For example, AI 250 may monitor activity patterns and flag potential security issues that would not otherwise be recognized by security rule 212. In this way, security layer 210 may be dynamic rather than static. As discussed above, in some cases AI 250 may be implemented using one or more machine learning models.

Container 200 also includes storage layer 220, which is configured to store data related to container 200. For example, storage layer 220 may include application libraries 222 related to applications installed within container 200 (e.g., applications 230). Storage layer 220 may also include application data 224, which may be produced by operation of applications 230. Storage layer 220 may also include reporting data 224, which may include data regarding the performance and activity of container 200. In certain embodiments, storage layer 220 also encompasses GPU memory 275. For example, various types of data related to container 200 may be stored in GPU memory 275. In some embodiments, one or more software applications are installed within container 200 to allow container 200 to interface with GPU memory 275, such as NVIDIA® CUDA®, ROCm, Vulkan™ by Khronos® Group, Apple® Metal® 2, openCL, openGL, or Microsoft® Directx®/direct3d®.

Storage layer 220 is flexible in that the amount of storage needed by container 200 may vary based on current job loads and configurations. In this way, container 200's overall size need not be fixed and therefore need not waste space on node 280.

Notably, the components of storage layer 220 depicted in FIG. 2 are just one example, and many other types of data may be stored within storage layer 220.

Container 200 also includes application layer 230, which comprises applications 232, 234, and 236 loaded within container 200. Applications 232, 234, and 236 may perform a wide variety of processing tasks as assigned by, for example, workload orchestration module 114 of FIG. 1. In some cases, applications within application layer 230 may be configured by application orchestration module 116 of FIG. 1.

The number and type of applications loaded into container 200 may be based on one or more roles defined for node 280. For example, one role may call for application 232 to be installed, and another role may call for applications 234 and 236 to be installed. Because the roles assigned to a particular node (such as node 280) are dynamic, the number and type of applications installed within container 200 may likewise be dynamic.

Container 200 also includes interface layer 240, which is configured to give container 200 access to local resources of node 280 (e.g., by way of local OS interface 242 and GPU interface 244) as well as to interface with a management system, such as management system 100 described above with respect to FIG. 1 (e.g., via remote interface 246).

Local OS interface module 242 enables container 200 to interact with local OS 260, which gives container 200 access to local resources 270. In this example, local resources 270 include a central processing unit (CPU) 272 (e.g., which may be representative of one or more CPUs with one or more cores), GPU 273 with associated GPU memory 275, memory 274, storage 276, and I/O 278 of node 280.

In some embodiments, not shown, local resources 270 may further include one or more special purpose processors (SPPUs), such as processors optimized for machine learning.

Local resources 270 also include one or more general memories 274 (e.g., volatile and non-volatile memories), one or more storages 276 (e.g., spinning or solid state storage devices), and I/O 278 (e.g., networking interfaces, display outputs, etc.).

GPU interface 244 may enable container 200 to interact with GPU 273 and GPU memory 275. For example, GPU interface 244 may access GPU 273 and GPU memory 275 directly via drivers, through an application programming interface (API), or through another type of interface. In some embodiments, GPU interface 244 accesses GPU memory 275 as a proxy for other applications, such as applications 232, 234, and 236. In other embodiments, GPU interface 244 exposes GPU memory 275 to other applications as a network service, shared memory device, or locally to node 280 as a filesystem.

Remote interface module 244 provides an interface with a management system, such as management system 100 described above with respect to FIG. 1. For example, container 300 may interact with container orchestration module 112, workload orchestration module 114, application orchestration module 116, and others of management system 100 by way of remote interface 244. As described in more detail below, remote interface module 244 may implement custom protocols for communicating with management system 100.

Container 200 includes a local AI 250. In some examples, AI 250 may be a local instance of AI module 118 described with respect to FIG. 1, while in others AI 250 may be an independent, container-specific AI. In some cases, AI 250 may exist as separate instances within each layer of container 200. For example, there may be an individual AI instance for security layer 210 (e.g., to help identify non-rule based security issues), storage layer 220 (e.g., to help analyze application data), application layer 230 (e.g., to help perform specific job tasks), and/or interface layer 240 (e.g., to interact with a system-wide AI).

A node agent 246 may be installed within local OS 260 (e.g., as an application or OS service) to interact with a management system, such as management system 100 described above with respect to FIG. 1. Examples of local OSes include MICROSOFT WINDOWS®, MAC OS®, LINUX®, and others.

Node agent 246 may be installed by a node orchestration module (such as node orchestration module 110 described with respect to FIG. 1) as part of initially setting up a node to work within a distributed computing system. When installing node agent 246 on certain operating systems, like MICROSOFT WINDOWS®, an existing software tool for remote software delivery, such as MICROSOFT® System Center Configuration Manager (SCCM), may be used to install node agent 246. In some cases, node agent 246 may be the first tool installed on node 280 prior to provisioning container 200.

Generally, node agent 246 is a non-virtualized, native application or service running as a non-elevated (e.g., user-level) resident process on each node. By not requiring elevated permissions, node agent 246 is easier to deploy in managed environments where permissions are tightly controlled. Further, running node agent 246 as a non-elevated user-level protects user experience because it avoids messages or prompts, which require user attention, such as WINDOWS® User Account Control (UAC) pop-ups.

Node agent 246 may function as an intermediary between the management system and container 200 for certain functions. Node agent 246 may be configured to control aspects of container 200, for example, enabling the running of applications (e.g., applications 232, 234, and 236), or even the enabling or disabling of container 200 entirely.

Node agent 246 may provide node status information to the management system, e.g., by querying the local resources 270. The status information may include, for example, CPU and GPU types, clock speed, memory size, type and version of the operating system, etc.

Node agent 246 may also provide container status information, e.g., by querying container 200 via local OS interface 242.

Notably, node agent 246 may not be necessary on all nodes. Rather, node agent 246 may be installed where necessary to interact with operating systems that are not inherently designed to host distributed computing tools, such as container 200, and to participate in heterogeneous distributed computing environments, such as described with respect to FIG. 1.

In certain embodiments, node agent 246 receives data for storage, such as from system manager 108 of FIG. 1 or from an application running within container 200, such as one of applications 232, 234, and 236. The data may include, for example, application data, application files, node state data, monitoring data, security rules, roles data, model data, and the like. Node agent 246 may determine where to store the data based on resource availability information determined via components of interface layer 240.

For example, node agent 246 may interact with GPU interface 244 in order to determine whether there is available space in GPU memory 275 to store the data. Upon determining that there available space in GPU memory 275, node agent 246 may store the data in GPU memory 275. For example, node agent 246 may use GPU interface 244 to allocate the data for storage in GPU memory 275 as texture data (e.g., using a graphics library such as OpenGL), as one or more direct memory buffers (e.g., using drivers of GPU 273), or as higher-level software abstractions (e.g., using libraries like OpenCL). In other embodiments, one or more of applications 232, 234, and 236 may directly determine resource availability and store data in GPU memory 275.

In some embodiments, node agent 246 continues to monitor demand for GPU memory 275, such as via GPU interface 244. For example, node agent 246 may regularly query or receive updates from GPU interface 244 regarding access by other components of local OS 260 to GPU memory 275. If node agent 246 determines that another component of local OS 260, such as a graphical application, is seeking access to portions of GPU memory 275 in which data has been stored by node agent 246, then node agent 246 may evacuate the data from GPU memory 275 so as not to interfere with normal use of GPU memory 275. Evacuation of data may, for instance, involve removing the data from GPU memory 275 and storing it in another location, such as memory 274, storage 276, or another local or remote storage entity.

By regularly monitoring demand for GPU memory 275, techniques described herein allow for GPU memory 275 to be utilized in a non-intrusive manner by storing data in unutilized resources of GPU memory 275 and evacuating the data when the resources are requested by another component during normal operation of node 280. For instance, requests for resources of GPU memory 275 from components that are not managed by node agent 246, such as graphical applications running in local OS 260, may be treated as having a higher priority than requests for resources of GPU memory 275 from components that are managed by node agent 246, such as from entities within container 200. As such, data may be evacuated when from GPU memory 275 if it corresponds to a lower priority request in order to make room for a higher priority request.

### Example of Utilizing Available GPU Memory for Distributed in Platform Data Storage

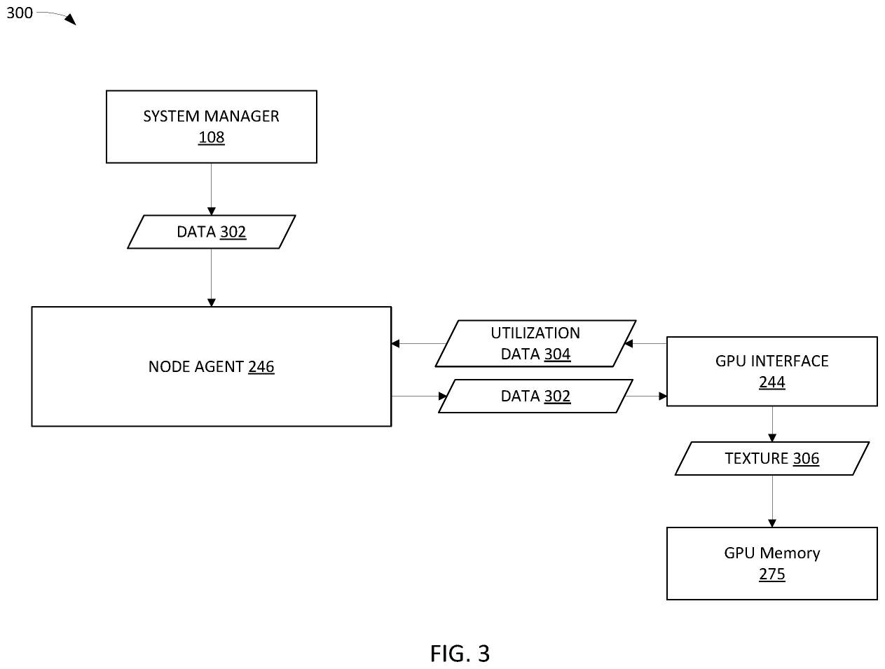

FIG. 3 depicts an example 300 of storing data in GPU memory in a heterogeneous distributed computing resource management system, such as system 100 in FIG. 1. Example 300 includes system manager 108 of FIG. 1 and node agent 246, GPU interface 244, and GPU memory 275 of FIG. 2.

In example 300, data 302 is sent from system manager 108 to node agent 246. For example, data 302 may represent a data set for training a machine learning model, and may be sent from system manager 108 to node agent 246 for storage and/or processing on node 280 of FIG. 2.

Node agent 246 receives utilization data 304 from GPU interface 244. For example, utilization data 304 may represent current usage and availability of resources in GPU memory 275. In some embodiments, node agent 246 requests utilization data 304 from GPU interface 244, while in other embodiments GPU interface 244 provides utilization data 304 to node agent 246 without receiving a request, such as at regular intervals.

Node agent 246 determines, based on utilization data 304, whether there are sufficient resources in GPU memory 275 to store data 302. Upon determining that there are sufficient available resources, node agent 246 provides data 302 to GPU interface 244 for storage in GPU memory 275.

In some implementations, GPU interface 244 allocates data 302 as a texture 306 for storage in GPU memory 275. Textures are a standard format in which data may be stored in memory of a GPU, as GPUs are generally designed to process graphics-related data. As such, converting data 302 into texture 306 is one possible method of storing data 302 in GPU memory 275. In other embodiments (not depicted), data 302 may be allocated as one or more direct memory buffers or as one or more high-level software abstractions for storage in GPU memory 275.

Node agent 246 may regularly monitor demand for GPU memory 275 through interactions with GPU interface 244. Upon recognizing a contention for the resources of GPU memory 275 in which texture 306 is stored (e.g., from another OS component or application), node agent 246 may evacuate texture 306 from GPU memory 275 and store data 302 in another local or remote location.

Storing data in GPU memory 275 provides many benefits. For example, by storing data in GPU memory 275, conventional system memory, such as memory 274, remains unaffected. Furthermore, GPU memory usage is often not reported to users, such as through task managers, and so a user is not likely to notice and/or interfere with the use (e.g., by cancelling a perceived unnecessary process utilizing large amounts of GPU memory). As such, GPU memory resources may be used with no identifiable cost to the underlying machine.

In some cases, using GPU memory 275 for storage of data may also provide performance benefits. For example, GPU memory is generally designed to run at high speeds for quick access, and so data stored in GPU memory 275 may be accessed quickly, such as for use in processing where the storage location of the data is not important, such as transient file storage, intermediate calculation scratch space, aggregating work results before sending them back to a requesting entity, file caching, database temporary tables, and the like.

### Example Methods Performed by a Heterogeneous Distributed Computing Resource Management System

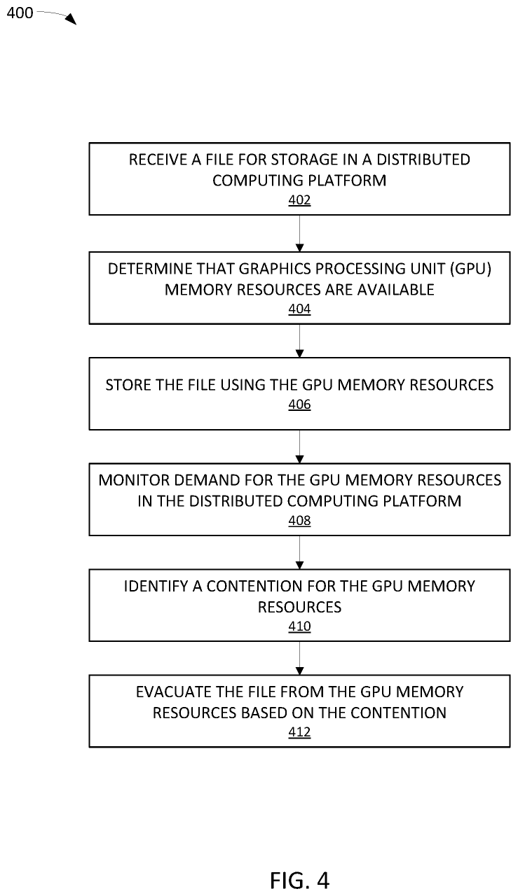

FIG. 4 depicts example operations 400 for storing data in a distributed computing system, such as system 100 in FIG. 1. In some embodiments, operations 400 are performed by node agent 246 of FIG. 2.

Operations 400 begin at step 402, where data is received for storage in a distributed computing platform. For example, the data may be received by node agent 246 of FIG. 2, such as from system manager 108 of FIG. 1 or from an application running within container 200 of FIG. 2. The data may comprise, for example, application data, node state data, monitoring data, security rules, roles data, model data, and the like.

Operations 400 then proceed to step 404, where it is determined that GPU memory resources are available. For example, node agent 246 of FIG. 2 may receive availability information regarding GPU memory 275 of FIG. 2 via GPU interface 244 of FIG. 2. Node agent 246 of FIG. 2 may determine, based on the availability information, that there is a sufficient amount of storage space available in GPU memory 275 of FIG. 2 to store the data. In some implementations, a sufficient amount may be based on a percentage of the total accessible GPU memory, such as the GPU memory is accessible if at least 50% of the GPU memory is not in use. In other implementations, a sufficient amount may be based more simply on whether the GPU has adequate free memory to store the data.

Operations 400 then proceed to step 406, where the data is stored in the GPU memory resources. For example, node agent 246 of FIG. 2 may store the data in GPU memory 275 of FIG. 2 via GPU interface 244 of FIG. 2. In some embodiments, the data is stored in GPU memory 275 of FIG. 2 by allocating the data as texture data, such as using a graphics library. In other embodiments, the data is stored in GPU memory 275 of FIG. 2 by allocating the data as one or more direct memory buffers, such as using drivers. In other embodiments, the data is stored in GPU memory 275 of FIG. 2 by allocating the data as one or more high-level software abstractions, such as using a library.

Operations 400 then proceed to step 408, where demand for the GPU memory resources in the distributed computing platform is monitored. For example, node agent 246 of FIG. 2 may monitor demand for resources of GPU memory 275 of FIG. 2 via GPU interface 244 of FIG. 2.

Operations 400 then proceed to step 410, where a contention for the GPU memory resources is identified. For example, node agent 246 of FIG. 2 may determine, via GPU interface 244 of FIG. 2, that a request for resources of GPU memory 275 of FIG. 2 was submitted by a graphical application running in local OS 260 of FIG. 2, and that there are insufficient resources in GPU memory 275 of FIG. 2 to service the request and continue to store the data in GPU memory 275 of FIG. 2.

Operations 400 then proceed to step 412, where the data is evacuated from the GPU memory resources based on the contention. For example, node agent 246 of FIG. 2 may remove, via GPU interface 244 of FIG. 2, the data from GPU memory 275 of FIG. 2 so that the request from graphical application running in local OS 260 of FIG. 2 can be services. Node agent 246 of FIG. 2 may store the data in another local or remote storage location, such as in memory 274 of FIG. 2.

Notably, the steps of operations 400 described above are just some examples. In other embodiments, some of the steps may be omitted, additional steps may be added, or the order of the steps may be altered. Operations 400 are described for illustrative purposes and are not indicative of the total range of capabilities of, for example, management system 100 of FIG. 1.

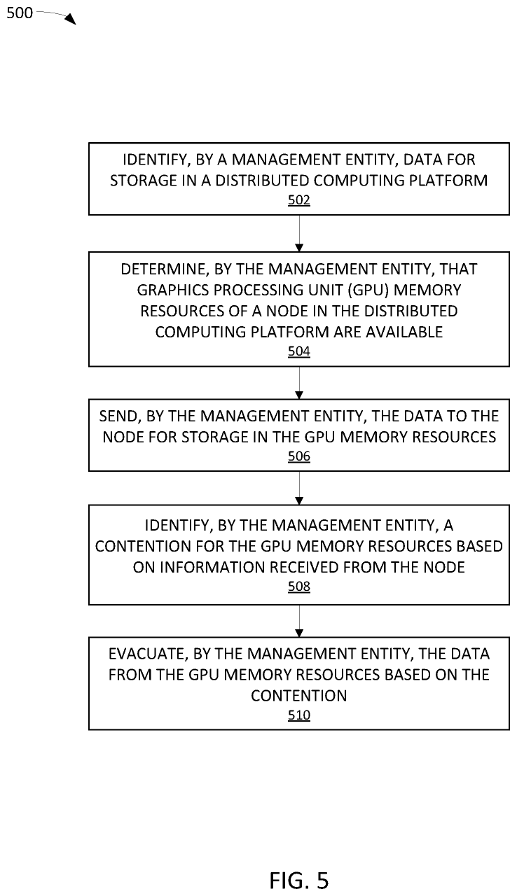

FIG. 5 depicts example operations 500 for storing data in a distributed computing system, such as system 100 in FIG. 1. In some embodiments, operations 500 are performed by system manager 108 of FIG. 1.

Operations 500 begin at step 502, where data is identified by a management entity for storage in a distributed computing platform. For example, system manager 108 of FIG. 1 may manage storage of data in the distributed computing platform, and may store individual items of data, such as files or portions of files, at various storage locations in the distributed computing platform. The data may comprise, for example, application data, node state data, monitoring data, security rules, roles data, model data, and the like.

Operations 500 then proceed to step 504, where it is determined by the management entity that GPU memory resources of a node in the distributed computing platform are available. For example, node agent 246 of FIG. 2 may send availability information regarding GPU memory 275 of FIG. 2, determined via GPU interface 244 of FIG. 2, to system manager 108 of FIG. 1. System manager 108 of FIG. 1 may determine, based on the availability information, that there is a sufficient amount of storage space available in GPU memory 275 of FIG. 2 to store the data. In some implementations, a sufficient amount may be based on a percentage of the total accessible GPU memory, such as the GPU memory is accessible if at least 50% of the GPU memory is not in use. In other implementations, a sufficient amount may be based more simply on whether the GPU has adequate free memory to store the data.

Operations 500 then proceed to step 506, where the data is sent by the management entity to the node for storage in a memory of the GPU. For example, system manager 108 of FIG. 1 may send the data to node agent 246 of FIG. 2, which may store the data in GPU memory 275 of FIG. 2 via GPU interface 244 of FIG. 2. In some embodiments, system manager 108 of FIG. 1 instructs node agent 246 of FIG. 2 to store the data in GPU memory 275 of FIG. 2 by allocating the data as texture data, such as using a graphics library. In other embodiments, system manager 108 of FIG. 1 instructs node agent 246 of FIG. 2 to store the data in GPU memory 275 of FIG. 2 by allocating the data as one or more direct memory buffers, such as using drivers. In other embodiments, system manager 108 of FIG. 1 instructs node agent 246 of FIG. 2 to store the data in GPU memory 275 of FIG. 2 by allocating the data as one or more high-level software abstractions, such as using a library.

Operations 500 then proceed to step 508, where a contention for the storage resources of the GPU is identified by the management entity. For example, node agent 246 of FIG. 2 may send information indicating one or more requests for the GPU memory resources to system manager 108 of FIG. 1. System manager 108 of FIG. 1 may receive the information and determine that there are insufficient resources in GPU memory 275 of FIG. 2 to service the one or more requests and continue to store the data in GPU memory 275 of FIG. 2.

Operations 500 then proceed to step 510, where the data is evacuated by the management entity from the GPU memory resources based on the contention. For example, system manager 108 of FIG. 1 may instruct node agent 246 of FIG. 2 to remove, via GPU interface 244 of FIG. 2, the data from GPU memory 275 of FIG. 2 so that the one or more requests can be serviced. System manager 108 of FIG. 1 may store the data in another local or remote storage location, such as in memory 274 of FIG. 2.

Notably, the steps of operations 500 described above are just some examples. In other embodiments, some of the steps may be omitted, additional steps may be added, or the order of the steps may be altered. Operations 500 are described for illustrative purposes and are not indicative of the total range of capabilities of, for example, management system 100 of FIG. 1.

It is noted that, while certain embodiments described herein involve the use of a software interface, such as GPU interface 244 of FIG. 2, to access GPU memory, other embodiments may involve directly accessing GPU memory to perform read and write operations.

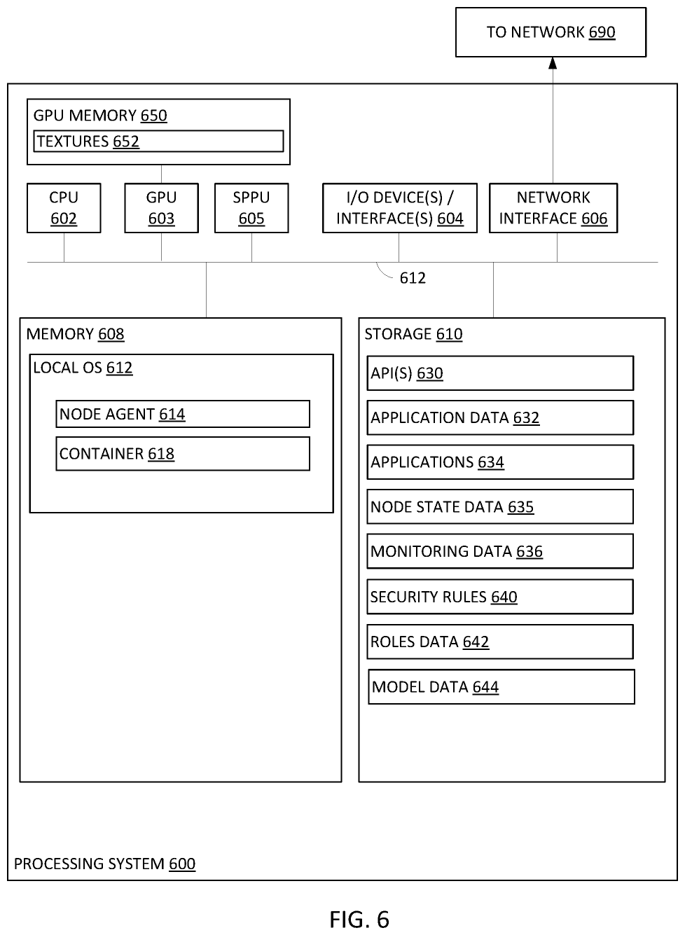

FIG. 6 depicts a processing system 600 that may be used to perform methods described herein, such as the operations for storing data in a distributed computing system described above with respect to FIG. 4. Certain components of processing system 600 may also be used to perform operations for storing data in a distributed computing system described above with respect to FIG. 5.

Processing system 600 includes a CPU 602, GPU 603 with associated GPU memory 650, and SPPU 605 all connected to a data bus 612. CPU 602, GPU 603, and SPPU 605 are configured to process computer-executable instructions, e.g., stored in memory 608, GPU memory 650, or storage 610, and to cause processing system 600 to perform methods as described herein, for example with respect to FIG. 4. Though depicted as only including only one CPU 602, GPU 603, and SPPU 605, processing system 600 may have more than one of each type of processor. Further, in some implementations, processing system 600 may not have each type of processing unit. For example, another implementation of processing system 600 may only include CPU 602 and GPU 603. FIG. 6 is merely one example of a processing unit configured to execute the methods described herein.

Processing system 600 further includes input/output device(s) and interface(s) 604, which allows processing system 600 to interface with input/output devices, such as, for example, keyboards, displays, mouse devices, pen input, and other devices that allow for interaction with processing system 600. Note that while not depicted with independent external I/O devices, processing system 600 may connect with external I/O devices through physical and wireless connections (e.g., an external display device).

Processing system 600 further includes network interface 606, which provides processing system 600 with access to external networks, such as network 690, and thereby external computing devices.

Processing system 600 further includes memory 608, which in this example includes local OS 612, comprising node agent 614 and container 618, which are generally representative of local OS 260, node agent 246, and container 200 of FIG. 2.

Note that while shown as a single memory 608 in FIG. 6 for simplicity, the various aspects stored in memory 608 may be stored in different physical memories, but all accessible to CPU 602 via internal data connections, such as bus 612, or external data connections, such as network interface 606 or I/O device interfaces 604.

Processing system 600 further includes GPU memory 650, which in this example includes textures 652, such as described above with respect to FIGS. 1-4. In other embodiments (not depicted), data is stored in GPU memory 650 as direct memory buffers and/or high-level software abstractions.

Processing system 600 further includes storage 610, which in this example includes application programming interface (API) data 630, such as described above with respect to FIGS. 1-4. In some embodiments, API data 630 may be stored in GPU memory 650, such as in the form of textures 652.

Storage 610 further includes application data 632, such as described above with respect to FIGS. 1-4. In some embodiments, application data 632 may be stored in GPU memory 650, such as in the form of textures 652.

Storage 610 further includes applications 634 (e.g., installation files, binaries, libraries, etc.), such as described above with respect to FIGS. 1-4. In some embodiments, applications 634 may be stored in GPU memory 650, such as in the form of textures 652.

Storage 610 further includes node state data 636, such as described above with respect to FIGS. 1-4. In some embodiments, node state data 636 may be stored in GPU memory 650, such as in the form of textures 652.

Storage 610 further includes monitoring data 638, such as described above with respect to FIGS. 1-4. In some embodiments, monitoring data 638 may be stored in GPU memory 650, such as in the form of textures 652.

Storage 610 further includes security rules 640, such as described above with respect to FIGS. 1-4. In some embodiments, security rules 640 may be stored in GPU memory 650, such as in the form of textures 652.

Storage 610 further includes roles data 642, such as described above with respect to FIGS. 1-4. In some embodiments, roles data 642 may be stored in GPU memory 650, such as in the form of textures 652.

Storage 610 further includes model data 644, such as described above with respect to FIGS. 1-4. In some embodiments, model data 644 may be stored in GPU memory 650, such as in the form of textures 652.

While not depicted in FIG. 6, other aspects may be included in storage 610.

As with memory 608, a single storage 610 is depicted in FIG. 6 for simplicity, but the various aspects stored in storage 610 may be stored in different physical storages, but all accessible to CPU 602 via internal data connections, such as bus 612, I/O interfaces 604, or external connection, such as network interface 606.

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for in-platform data storage, comprising:
receiving data for storage in a distributed computing platform;
determining that graphics processing unit (GPU) memory resources are available;
storing the data in the GPU memory resources;
monitoring demand for the GPU memory resources in the distributed computing platform;
identifying a contention for the GPU memory resources; and
evacuating the data from the GPU memory resources based on the contention.

2. The method of claim 1, wherein storing the data using the GPU memory resources comprises allocating the data as texture data using a library associated with the GPU.

3. The method of claim 1, wherein storing the data using the GPU memory resources comprises allocating the data as a direct memory buffer via a driver associated with the GPU.

4. The method of claim 1, wherein storing the data using the GPU memory resources comprises allocating the data as a high-level software abstraction via a library associated with the GPU.

5. The method of claim 1, wherein determining that the GPU memory resources are available comprises sending a request for utilization information to an interface application associated with the GPU.

6. The method of claim 1, wherein identifying the contention for the GPU memory resources comprises determining that another entity has requested to store second data in the GPU memory resources.

7. The method of claim 1, wherein evacuating the data from the GPU memory resources based on the contention comprises:
removing the data from the GPU memory resources; and
storing the data in a memory location that is separate from the GPU.

8. A method for in-platform data storage, comprising:
identifying, by a management entity, data for storage in a distributed computing platform;
determining, by the management entity, that graphics processing unit (GPU) memory resources of a node in the distributed computing platform are available;
sending, by the management entity, the data to the node for storage in the GPU memory resources;
identifying, by the management entity, a contention for the GPU memory resources based on information received from the node; and
evacuating, by the management entity, the data from the GPU memory resources based on the contention.

9. The method of claim 8, wherein sending, by the management entity, the data to the node for storage in the GPU memory resources comprises instructing a component of the node to allocate the data as texture data using a library associated with the GPU.

10. The method of claim 8, wherein sending, by the management entity, the data to the node for storage in the GPU memory resources comprises instructing a component of the node to allocate the data as a direct memory buffer via a driver associated with the GPU.

11. The method of claim 8, wherein sending, by the management entity, the data to the node for storage in the GPU memory resources comprises instructing a component of the node to allocate the data as a high-level software abstraction via a library associated with the GPU.

12. The method of claim 8, wherein determining, by the management entity, that the GPU memory resources of the node are available comprises receiving utilization information from a component of the node.

13. The method of claim 8, wherein evacuating, by the management entity, the data from the GPU memory resources based on the contention comprises:
instructing a component of the node to remove the data from the GPU memory resources; and
storing the data in a memory location in the distributed computing platform that is separate from the GPU.

14. An apparatus, comprising:
a memory comprising computer-executable instructions; and
a processor in data communication with the memory and configured to execute the computer-executable instructions and cause the apparatus to perform a method for in-platform data storage, the method comprising:
receiving data for storage in a distributed computing platform;
determining that graphics processing unit (GPU) memory resources are available;
storing the data in the GPU memory resources;
monitoring demand for the GPU memory resources in the distributed computing platform;
identifying a contention for the GPU memory resources; and
evacuating the data from the GPU memory resources based on the contention.

15. The apparatus of claim 14, wherein storing the data using the GPU memory resources comprises allocating the data as texture data using a library associated with the GPU.

16. The apparatus of claim 14, wherein storing the data using the GPU memory resources comprises allocating the data as a direct memory buffer via a driver associated with the GPU.

17. The apparatus of claim 14, wherein storing the data using the GPU memory resources comprises allocating the data as a high-level software abstraction via a library associated with the GPU.

18. The apparatus of claim 14, wherein determining that the GPU memory resources are available comprises sending a request for utilization information to an interface application associated with the GPU.

19. The apparatus of claim 14, wherein identifying the contention for the GPU memory resources comprises determining that another entity has requested to store second data in the GPU memory resources.

20. The apparatus of claim 14, wherein evacuating the data from the GPU memory resources based on the contention comprises:
removing the data from the GPU memory resources; and
storing the data in a memory location that is separate from the GPU.
